(19) United States
(12) Patent Application Publication
(10) Pub. No.: US 2026/0042600 A1
(43) Pub. Date: Feb. 12, 2026

(54) Collapsible Container with Bags Integrated into the Lid

(71) Applicant: Box Holdco, LLC, New York, NY (US)

(72) Inventor: Christian Desrosiers, New York, NY (US)

(73) Assignee: Box Holdco, LLC, New York, NY (US)

(21) Appl. No.: 18/796,613

(22) Filed: Aug. 7, 2024

(51) Int. Cl. B65F 1/06; B60R 9/06; B60R 13/01; B62D 33/027; B65D 33/00; B65F 1/16; B65F 3/00

(52) U.S. Cl. CPC B65F 1/062; B60R 9/06; B60R 13/01; B62D 33/027; B65D 33/001; B65F 1/16; B65F 2003/006; B65F 2220/1063

(57) ABSTRACT

A collapsible container with nested bags in a removable lid of the collapsible container, comprising a base, set of walls, removable lid on top of the container, and the lid having an aperture for waste. There is a set of nested bags adhesively connected to the lid. The set of bags having a first bag followed by an adjacent g, with the bags removable through the aperture of the lid. An adhesive first connection strip circumferentially wraps the set of bags about the lid adjacent the rim, the first bag and adjacent bag each having their own first connection strip, the first connection strip having a pull tag, the pull tag configured to separate the first bag and adjacent bag from the lid. A second connection strip integrated in a vertical direction into the set of bags and the set of walls.

### FIELD OF THE INVENTION

A collapsible container with bags integrated into the lid as a means to improve waste disposal.

### Problem to be Solved

Often, construction site workers have two challenges that they face; where to place their trash and where they can use the restroom. First, construction sites typically do not have trash cans available to collect garbage from the site and from workers. This can lead to a large amount of litter in and around the site. Even if there is a makeshift garbage can, such as an oil drum, it can be difficult to place bags in this type of container, leading to trash sitting and decomposing within the can. This would then require the trash to be scooped out or tipped over to remove the trash, with both tasks being difficult due to the container's shape and size. This same issue can be present at other sites such as camp sites, outdoor concerts, weddings, festivals, state fair grounds, and any other event that may be held outside or at a non-traditional indoor venue. Therefore, it would be advantageous to provide a different type of trash collection approach to situations such as the above so that trash collection is easier. As well, it would be advantageous to have this new approach be environmentally friendly.

Second, these same sites, such as construction sites, camp sites, festivals, beaches, etc., often do not have areas for people to use the restroom. Even if these sites do have restrooms they are usually limited in nature. This can lead to people relieving themselves in inappropriate areas, especially occurring at campsites and beaches, resulting in health hazards in or around the site. Therefore, it would be advantageous if someone could bring their own portable restroom or if the site could install temporary restrooms only utilized when necessary. It would also be advantageous to have this new approach to restrooms be environmentally friendly.

### DESCRIPTION OF PRIOR ART

All prior art references are in reference to the issued U.S. Pat. No. 11,958,683 B1 (“Patent '683”), which the presently disclosed invention intends to improve upon. Patent '683 is an invention for a collapsible container system that includes nested bags with a first and a second connector ribbon. The first connector ribbon connects the bag to the rim of the container, and the second ribbon connects the bags to the vertical portion of the container's wall. However, these configurations lack the capability to be used as a restroom, as this new invention will reveal. Additionally, the '683 invention lacks transportability and rigidity. All other prior art relates to a waste container or bag system that is not suitable for the purposes of this invention. Rather, the improvements to Patent '683 disclosed herein improves upon what the prior art fails to accomplish.

### OBJECTIVE OF THE INVENTION

This invention intends to provide an improved system for collection of both organic and inorganic waste. The invention will have the capability to operate as both a garbage can and a toilet. The collapsible container with a lid having a set of bags for the disposal of organic and inorganic waste in some embodiments will be portable, sturdy, customizable, connectible, and environmentally friendly.

### SUMMARY OF THE INVENTION

In one embodiment, the container with a lid has a set of a plurality of bags for the disposal of organic and inorganic waste. The container is configured to be used as a toilet. In this embodiment, a container for the waste can be assembled from sturdy cardboard wherein a box is formed with enough strength to support a user sitting on the container. This embodiment includes a removable lid on the container. The lid has an aperture suitable for both Male and Female users to relieve themselves. Within the container itself is a set of bags that are secured about the lid and down the sides of the container via a first and second connection strip. These connector strips in some embodiments can be but are not limited to, an adhesive strip to ensure a proper, strong connection between the nested bags and the container. Both connectors may include a manually engageable tab to ease the removal of the bag after use. In another embodiment, the nested bags described above may instead be dispensed from a cylindrical nest at the bottom of the container. This embodiment and others may include a connectable partition to conceal the user. The container itself and this partition may be made of cardboard or other sturdy environmentally friendly materials such as but not limited to recyclable plastics. These embodiments and others may be used as a garbage container rather than a collapsible, portable toilet, if desired.

In another embodiment, the set of bags of the container may be attached to the walls of the container rather than the lid. In this system, the first connector strip adheres the set of nested bags to the wall rather than to the container's lid. The second connector strip still runs vertically with a pull tab to assist in removal of the bag after it has been used.

In yet another embodiment, the container itself may be assembled into various sizes. The container may have a plurality of sides and bottoms that can be adjoined to create a box reflective of the user's needs. These plurality of sides and bottoms could be adjoined with a modular partial ring to reach the desired size and shape. This shape may contain the nested bags described above or several sets of the nested bags described above.

The container itself, whether to be used as a toilet or garbage can, may have additional features. Such features may provide reinforcements\ for the box structure. These reinforcements may be single corner reinforcements or a continuous reinforcement member that runs along the bottom portion of the box. As well, non-reinforcement additions may be added in some embodiments such as hook and loop fasteners, interlocking handles, and flaps. The hook and loop fasteners could be used to secure the container to other objects. The interlocking handles could be interconnected in order to connect multiple containers together while also being functional handles. The flaps on the container would allow the container to be secured to the floor. All of the above mentioned features may be made of cardboard or other environmentally friendly materials. The features as well may be permanently attached or removable depending on the embodiment. As well, a NFC tag may be integrated into the container for the purpose of tracking and container management. An additional embodiment may include all the above mentioned features but have a physically integrated double sided clip to allow the placement of bags, whether that be from the nested bags or other bags.

An additional embodiment of the invention is a collapsible container sized to fit within the bed of a truck. In this embodiment, the set of nested bags can connect to an optional lid or the sides of the container. In this embodiment, the container may have a set of openings or a set of structures suited to receive the wheel well of a truck, if necessary. This embodiment may have a traditional set of four equally weighted walls to allow loading via the top of the container, or the wall abutting the gate of the truck may have an entrance for the trash.

### BRIEF DESCRIPTION OF DRAWINGS

FIG. 1 is a perspective view of the container with an apertured lid and a set of bags lodged inside the container.

FIG. 2 is a cross-section of the container of FIG. 1 with the bags attached to the lid.

FIG. 3 is a cross-section of the container of FIGS. 1 and 2 with the lid and a set of bags in the container.

FIG. 4 is a schematic illustration of the container expanding from a flat configuration to an open configuration.

FIG. 5 is a perspective view of the container with the lid and additional attachment features.

FIG. 6 is a perspective view of the lid with only the set of nested bags.

FIG. 7 is a perspective view of the container within a truck.

FIG. 8 is perspective view of the container within a truck having an entrance for trash.

### DETAILED DESCRIPTION

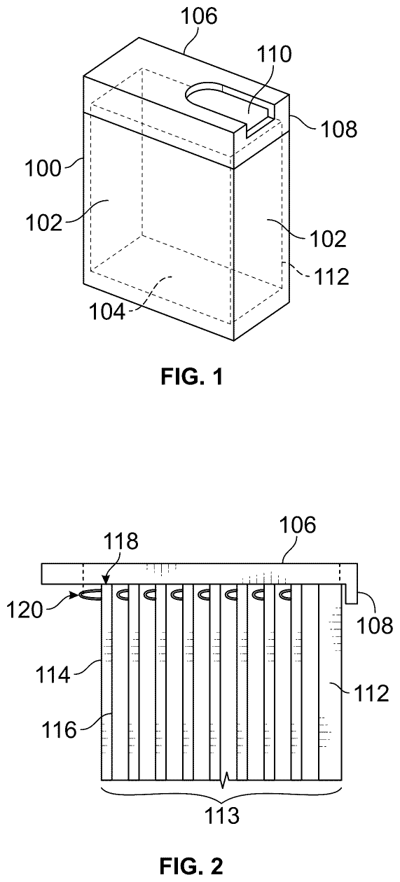

FIG. 1 shows a perspective view of the container 100. The container 100 has a set of walls 102 connected to the base 104 with a lid 106. The lid 106 has a downwardly extending lip 108 that extends over the top of the set of walls 102. The lid 106 has an aperture 110 within the lid 106 to allow for the ingress and disposal of organic and inorganic waste. A set of nested bags 112 lines the interior of the container 100, as depicted by ghost lines in FIG. 1.

FIG. 2 shows a partial cross-section view of the container 100. The set of nested bags 112 is shown connected to the lid 106 via the first connection strip 118. The first connection strip 118 circumferentially wraps about the set of nested bags 112. Each individual bag 113, the first bag 114 and the adjacent bag 116, have a first connection strip 118 adhesively adhered to the outside of each bag 113, and a pull tag 120 to assist removal of the bag through the lid's 106 aperture 110 of the container 100.

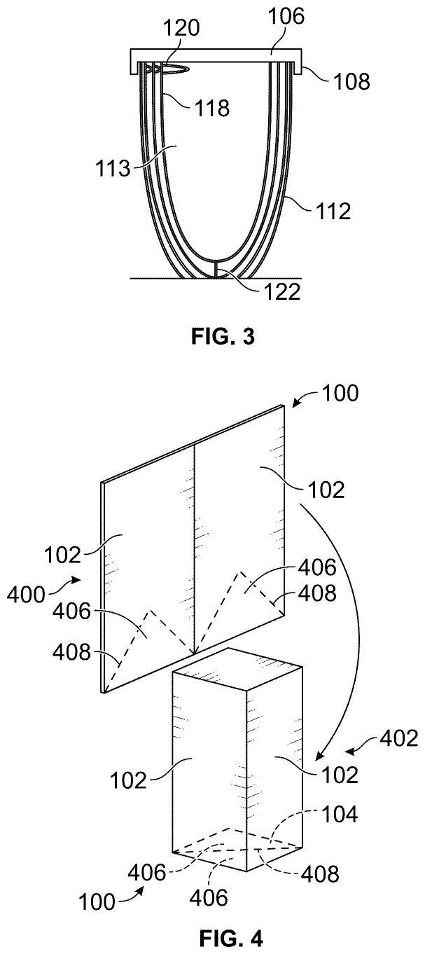

FIG. 3 depicts a cross-section of the container 100, lid 106 of container 100, and set of nested bags 112. Each bag 113 of the nested set of bags 112 are connected to the lid 106 via the first connection strip 118 and are connected internally to each other via a second connection strip 122 that lies near the bottom of the set of bags 112 adjacent to the base 104. The pull tag 120 is present on each bag within the set of bags 112.

FIG. 4 depicts the container 100 expanding from its first position 400 to its second position 402. The set of bottom panels 406 can be seen at the base 104 of the container 100. The set of bottom panels 406 creates a set of connections 408 to allow the container 100 to go from the collapsed first position 400 to the fully formed second position 402. The set of bottom panels move from the Y plane to the X plane to crease the base 104. In the second position 402, the container 100 can receive the lid of the container 106.

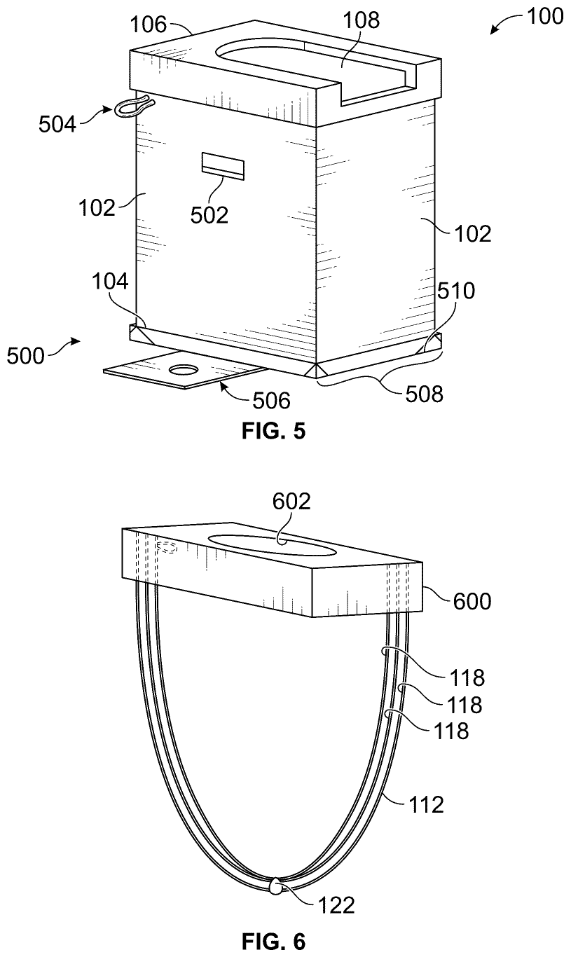

FIG. 5 depicts a perspective view of the container 100 with the lid of the container 108 and aperture 110. Shown in this figure are additional attachments that may be attached to the container 100. A set of handles 502 are depicted attached to the set of walls 102. The set of handles 502 allows the container to be picked up and secured with an additional container. The loop 504 on the container is attached to the set of walls 102 and allows the container 100 to be secured to another structure, such as a tree or pole. The flap 506 connects to the base of the container 104 and allows the container 100 to be secured or staked to the floor or external surface. A modular set of continuous reinforcements 508 surrounds the base of the container 104, extending horizontally into the X plane and vertically into the Y plane about the set of walls 102. The modular set of continuous reinforcements 508 may have corner reinforcement plates 510. The corner reinforcement plates 510 may be attached to the modular set of continuous reinforcements 508 or the container 100 itself. The modular set of continuous reinforcements 508 and corner reinforcement plates 510 may be but are not limited to being constructed from cardboard, laminated cardboard, or a recyclable plastic.

FIG. 6 depicts a separate embodiment wherein a modular lid 600 can be placed on any open vessel or container to create a receptacle. The nested set of bags 112, as described in conjunction with FIG. 3, attaches to the modular lid 600 via the first connection strip 118. The second connection strip 122 internally connects the set of bags 112 to each other. The modular lid 600 has an aperture 602 that allows for the disposal of organic and inorganic waste.

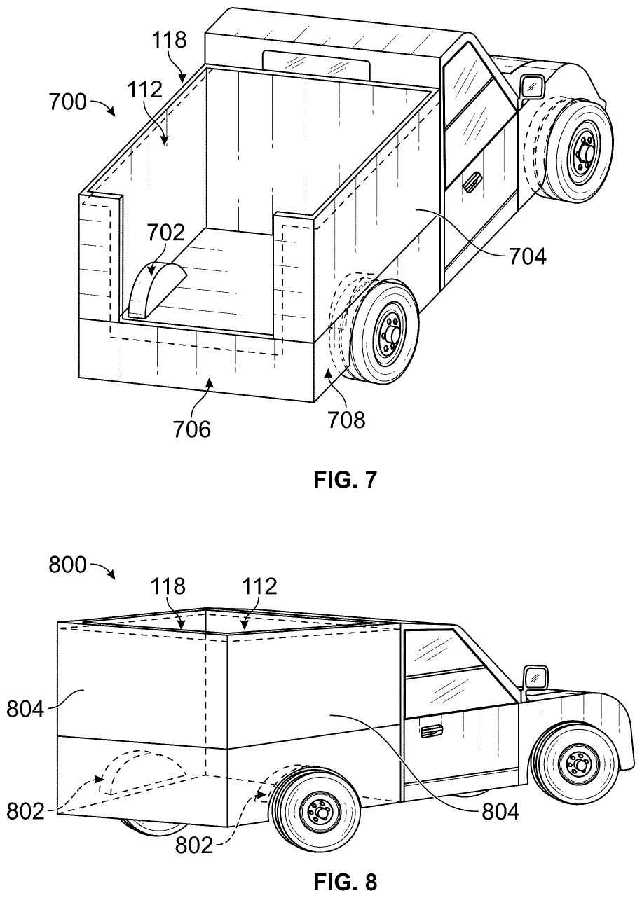

FIG. 7 is a perspective view of a container with an opening within the bed of a truck. Here, the container 700 is sized to fit within the bed of a truck. The container 700 in this embodiment has a set of openings 702 to receive the wheel wells of a truck, if necessary. The set of walls 704 in this embodiment has an opening 706 that abuts the gate of the truck to allow trash to easily enter. The set of nested bags 112 connects to the sets of walls 704 and opening 706 via the first connection strip 118. In this embodiment, the container 700 has an open top, but it can include a lid if necessary.

FIG. 8 is a perspective view of a container within the bed of a truck. Here, the container 800 is sized to fit within the bed of a truck. The container 800 in this embodiment has a set of openings 802 to receive the wheel well of the truck. The container 800 has a set of walls 804 which are all equal in height. The set of nested bags 112 are attached to the container 800 via the first connection strip 118. In this embodiment, the container 800 has an open top, but it can include a lid if necessary.

While the present disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A collapsible container with nested bags integrated into a removable lid of the collapsible container, comprising;
the collapsible container having a collapsible base, the collapsible base interconnected with a set of walls of the container, the set of walls defining a perimeter at the base of the container, the removable lid on top of the container, the lid having an aperture communicating with an interior of the container, the aperture configured to receive waste, the container and lid configured to support a user's body weight;
a set of nested bags adhesively connected to the lid, the set of nested bags having a first bag at an innermost position with an adjacent bag at the exterior of the first bag, the adjacent bag becoming the first bag upon removal of the first bag, the first bag and adjacent bag being removable through the aperture of the lid;
a first connection strip circumferentially wrapping the set of nested bags about the lid adjacent the rim, the first connection strip adhesively connecting the set of bags to the lid, the first bag and adjacent bag each having their own first connection strip, the first connection strip having a pull tag, the pull tag configured to separate the first bag and adjacent bag from the lid;
a second connection strip integrated in a vertical direction into the set of bags, the first and adjacent bag each having a second connection strip, the second connection strip being removable and adhesively connecting the set of bags to a wall of the set of walls of the container, the second connector strip connecting the first bag to the adjacent bag; and
the first bag being removable from the set of bags via the separation of the first connection strip and the second connection strip without disrupting the remaining first connection strips or the second connection strips.

2. The collapsible container of claim 1, wherein the container comprises at least four walls.

3. The collapsible container of claim 1, wherein the collapsible base of the container comprises a set of connections, the set of connections defining a set of panels, the set of panels being movable from a Y plane to an X plane.

4. The collapsible container of claim 1, wherein moving the set of panels from the Y plane to the X plane reconfigures the container from a first position to a second position, the first position being the container in its collapsed form, the second position being the container in its constructed expanded non-collapsed form.

5. The collapsible container of claim 1, wherein the set of panels interlock to form the base of the collapsible container.

6. The collapsible container of claim 1, wherein the first connection strip includes a plurality of apertures.

7. The collapsible container of claim 1, wherein the second connection strip includes a plurality of apertures.

8. The collapsible container of claim 1, wherein the pull tag is adhesively connected to the first connection strip.

9. The collapsible container of claim 1, wherein the lid and the set of nested bags are removable from the container upon disconnecting the second connector strip from the container.

10. The collapsible container of claim 1, wherein the collapsible container comprises a set of corner reinforcement plates, the set of corner reinforcement plates encompassing the corners of the exterior of the container.

11. The collapsible container of claim 10, wherein the set of corner reinforcements are removable.

12. The collapsible container of claim 1, wherein the collapsible container comprises a set of continuous reinforcements, each continuous reinforcement having a first and second portion, the first portion extending in the Y plane, the second portion extending in the X plane, the continuous reinforcements fitting about the external perimeter of the base of the collapsible container.

13. The collapsible container of claim 12, wherein the set of continuous reinforcements are removable.

14. The collapsible container of claim 1, wherein a set of inter-connecting handles are attached to the collapsible container, the set of interconnecting handles having a first handle and a second handle, the first handle being interconnectable with the second handle, the first handle connecting to the second handle of an adjacent second container, the first and second collapsible containers configured to connect to additional collapsible containers.

15. The collapsible container of claim 1, wherein a plurality of flaps are attached about the base of the container, the flaps extending in a horizontal direction from the base, the flaps configured to receive a stake.

16. The collapsible container of claim 1, wherein at least one loop is attached to the set of walls of the collapsible container, the at least one loop being hollow.

17. The collapsible container of claim 1, wherein a second collapsible container is formed from a second set of walls, the second set of walls being modular to connect a plurality of sets of walls, the plurality of sets of walls connected via a modular clip, the modular clip securing the plurality of sets of walls.

18. The collapsible container of claim 17, wherein the lid is removably placed on top of the second container, the lid having a plurality of nested bags removably attached to the lid.

19. The collapsible container of claim 1, wherein a partition is adjoined to the collapsible container, the partition having at least one wall, the at least one wall connected to the base of the container.

20. The collapsible container of claim 1, wherein the set of nested bags is secured to the lid with a double-sided clip, the double-sided clip attaching to the set of bags.

21. A Collapsible Container with nested bags integrated into the container comprising;
a container having a collapsible base, the collapsible base interconnected with a set of walls of the container, the set of walls defining a perimeter at the base of the container, the set of walls having at least one opening;
a set of nested bags adhesively connected to the set of walls and the at least one opening, the set of nested bags having a first bag at an innermost position with an adjacent bag at the exterior of the first bag, the adjacent bag becoming the first bag upon removal of the first bag, the first bag and adjacent bag being removable through the at least one opening;
a first connection strip circumferentially wrapping the set of nested bags about the set of walls and the at least one opening, the first connection strip adhesively connecting the set of bags to the set of walls and the at least one opening, the first bag and adjacent bag each having their own first connection strip, the first connection strip having a pull tag, the pull tag configured to separate the first bag and adjacent bag from the set of walls and at least one opening;
a second connection strip integrated in a vertical direction into the set of bags, the first and adjacent bag each having a second connection strip, the second connection strip being removable and adhesively connecting the set of bags to a wall of the set of walls of the container,
the second connector strip connecting the first bag to the adjacent bag; and
the first bag being removable from the set of bags via the separation of the first connection strip and the second connection strip without disrupting the remaining first connection strips or the second connection strips.

22. The collapsible container with nested bags intergraded into the container of claim 21, wherein the base of the container and the set of wells configured to receive a truck bed's wheel wells.

23. The collapsible container with nested bags intergraded into the container of claim 21, wherein the container may have a lid.

24. The collapsible container with nested bags intergraded into the container of claim 21, wherein the at least one opening has a ledge to prevent trash from escaping the opening.

25. The collapsible container with nested bags intergraded into the container of claim 21, wherein it has a set of loops on the container configured to secure the container to a truck bed.

26. The collapsible container with nested bags intergraded into the container of claim 21, wherein the set of walls has at least three walls.
